(19) United States
(12) Patent Application Publication
(10) Pub. No.: US 2016/0160867 A1
(43) Pub. Date: Jun. 9, 2016

(54) ELECTRICALLY COUPLED COUNTER-ROTATION FOR GAS TURBINE COMPRESSORS

(71) Applicant: Embry-Riddle Aeronautical University, Inc., Daytona, FL (US)

(72) Inventor: Vinod Gehlot, Bangalore (IN)

(21) Appl. No.: 14/849,941

(22) Filed: Sep. 10, 2015

Related U.S. Application Data
(63) Continuation of application No. PCT/US2014/023094, filed on Mar. 25, 2014.
(60) Provisional application No. 61/791,925, filed on Mar. 15, 2013.

(51) Int. Cl. F04D 27/00; F04D 25/06; F04D 29/32; F02C 3/067; F01D 15/10

(52) U.S. Cl. CPC F04D 27/004; F02C 3/067; F01D 15/10; F04D 29/325; F04D 25/06; F05D 2220/32; F05D 2240/60; F05D 2240/24; F05D 2240/35

(57) ABSTRACT

A system and method for implementing stage-by-stage counter rotation in a multi-stage axial compressor of a gas turbine engine. The system includes an electrical power generator and an electric motor. A turbine-driven shaft connected to an armature of the electrical generator drives a first plurality of compressor blades. The electrical generator armature induces changing magnetic flux in the stator coils of the electrical generator which generates electrical power that is sent to a power control module. The power control module controls the electrical motor and excites the coils in the electric motor stator which drives the electric motor armature. The electric motor armature drives a second shaft which drives a second plurality of compressor blades in an opposite direction to the first plurality of compressor blades.

### RELATED APPLICATIONS

This present Patent Application is a continuation of International Application No. PCT/US2014/23094, filed Mar. 25, 2014, by the inventor named in the present Application, which claims the benefit under 35 U.S.C. §119(e) of United States Provisional Patent Application No. 61/791,925, filed on Mar. 15, 2013, and entitled “Electrically Coupled Counter-Rotation for Gas Turbine Compressors,” both of which patent applications are incorporated by reference herein in their entireties as though fully set forth herein.

### TECHNICAL FIELD

Embodiments of the invention generally relate to axial flow compressors of gas turbine engines and, in particular, to axial flow compressors incorporating stage-by-stage counter-rotation utilizing electrical coupling between shafts.

### BACKGROUND

Axial compressors generally are designed to produce a substantially continuous flow of compressed gas or intake air passing therethrough to boost the power of gas turbine engines, such as jet engines for aircraft, high-speed ship engines, as well as some automotive reciprocating engines. In general, most axial compressors will include a series of air foils or blades arranged in stages that include pairs of rotating and stationary air foils. As an air flow enters the inlet of the compressor, the rotating air foils (rotors) drive the air forwardly through the compressor, increasing the kinetic energy thereof, while the stationary or static air foils (stators) diffuse the increased kinetic energy of the air flow passing thereover, causing a rise in pressure of the air flow. As a result, the pressure of the axial air flow through the compressor is significantly increased as it passes through multiple stages of the compressor.

However, the pressures and efficiencies provided by axial compressors can be limited by the size and weight of the compressor. For example, in aviation where minimizing compressor size and weight is critical to provide a lower profile, the higher stage pressure ratios provided by such smaller compressors typically are provided at the expense of compressor efficiency. Attempts have been made to design compressors with counter-rotation to try to increase the efficiency, and to reduce the size and number of axial compressors. The problem with such counter-rotating compressors has traditionally been that the blades of such counter-rotating compressors generally have been required to be on different driveshafts, which adds to the weight and complexity of the compressors, as well as potentially creating problems with synchronizing the operation of the counter-rotating blades, which further increases with an increased number of stages of the compressor.

Counter-rotation in gas turbine compressors has been known to augment engine performance by reducing the number of stages of rotating machinery, leading to lighter and compact gas turbine engines which are paramount to aerospace applications. Modern high performance aerospace engines, such as the General-Electric GE-90 series, Pratt & Whitney F-119, and Rolls-Royce Trent series, have counter-rotation incorporated between their low-pressure/high-pressure stages or intermediate-pressure/high-pressure stages, but not between the individual stages in compressors. This can be attributed to the complexity of mechanical mechanisms. Most mechanical mechanisms can be classified into two segments: (1) multi-shaft designs, and (2) gearbox coupling.

Multi-shaft designs and gearbox coupling use methods that are highly complex mechanically; as a result, no gas turbine engine to date has been designed with contra-rotation. Mechanical methods also impose significant limitations on the aerodynamic design of compressors due to their tight revolutions per minute (RPM) constraints. This limitation on the aerodynamic design limits compressor aerodynamic performance and negates the benefits of contra-rotation.

### SUMMARY

The embodiments disclosed are directed to axial compressors for gas turbine engines, the compressors incorporating rotating and contra-rotating stages. The contra-rotating stages of the axial compressor are mounted on a separate shaft that is electrically coupled to an electric motor.

In one embodiment, a system provides stage-by-stage counter rotation in a multi-stage axial compressor of a gas turbine engine. The system includes an electrical power generator and an electric motor each having an armature and a stator. A turbine-driven shaft connected to an armature of the electrical generator drives a first plurality of compressor blades. The electrical generator armature induces changing magnetic flux in the stator coils of the electrical generator which generates electrical power that is sent to a power control module. The power control module controls the electric motor and excites the coils in the electric motor stator which drives the electric motor armature. The electric motor armature drives a second shaft which drives a second plurality of compressor blades in an opposite direction to the first plurality of compressor blades.

### BRIEF DESCRIPTION OF THE DRAWINGS

These and other advantages and aspects of the embodiments of the disclosure will become apparent and more readily appreciated from the following detailed description of the embodiments taken in conjunction with the accompanying drawings, as follows.

FIG. 1 illustrates a side cross-sectional view of an electrically-coupled multi-stage axial compressor with counter-rotation in accordance with an exemplary embodiment.

FIG. 2 illustrates a more detailed side cross-sectional view of the electrically-coupled multi-stage axial compressor with counter-rotation in accordance with an exemplary embodiment.

FIG. 3 illustrates a perspective view of the electrically-coupled multi-stage axial compressor in accordance with an exemplary embodiment.

FIG. 4 illustrates a block diagram of the main components of the electrical coupling system in accordance with an exemplary embodiment.

### DETAILED DESCRIPTION

The following detailed description is provided as an enabling teaching of embodiments of the invention. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the invention and not in limitation thereof, since the scope of the invention is defined by the claims.

The disclosed embodiments provide several advantages over mechanical coupling systems including: (1) adaptable and precise control of contra-rotating shaft revolutions per minute (RPM), (2) no mechanical contact between contra-rotating shafts leading to vibration-free and quiet engine operation, and (3) accommodation of an all-electrical power takeoff

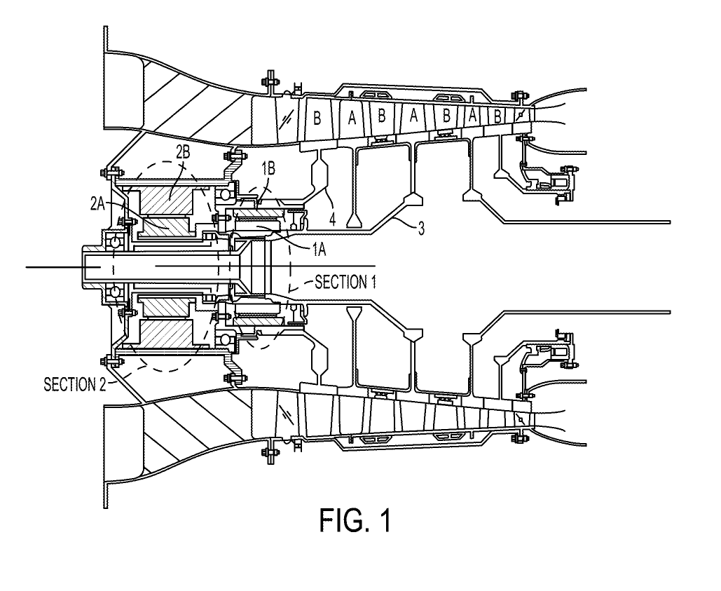

FIG. 1 illustrates a side elevation sectional view of an electrically-coupled multi-stage axial compressor with counter-rotation in an exemplary embodiment. This figure will be referred to in describing the principles of operation of the disclosed embodiments. The electrically-coupled components include a contra-rotating electrical power generator, labeled as section 1, and an electric motor, labeled as section 2. The main mechanical components of an electrical generator or electric motor are the rotor and stator; the main electrical components are the armature and magnetic field. Turbine-driven shaft 3 drives a plurality of compressor blades A and is connected to an armature 1A of the electrical generator. The rotating armature 1A induces changing magnetic flux in the stator coils 1B of the electrical generator. The changing magnetic flux in the stator coils 1B generates electrical power which is then sent to a power control module (PCM) (not shown). The PCM includes power electronics which control the electric motor 2 and also enables electrical power takeoff The PCM is controlled by the engine's full-authority digital engine control (FADEC) and excites the coils in stator 2B of the electric motor which drives armature 2A of the motor.

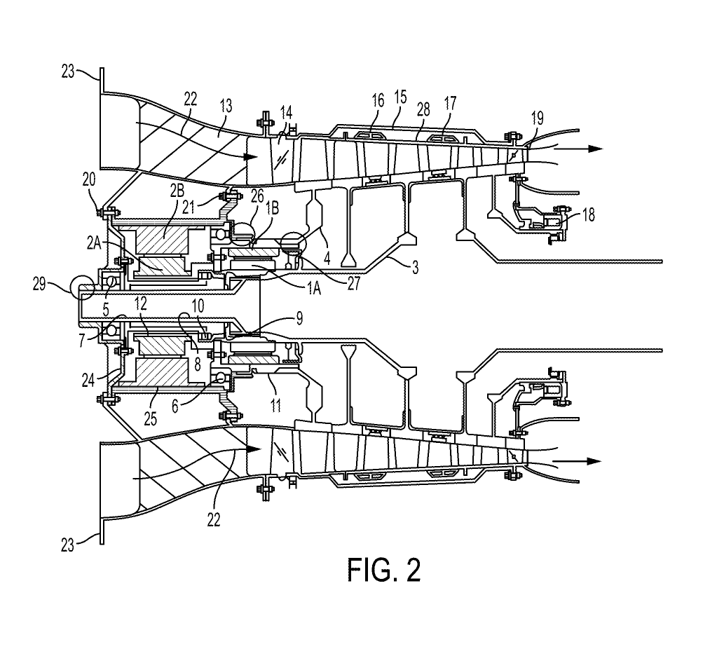

In the contra-rotating generator shown in FIGS. 1-2, the armature 1A counter-rotates with respect to the stator 1B. The generator stator is more broadly defined than it is in a commercial or industrial electrical generator or motor. The stator in the electrical generator disclosed herein is connected to shaft 4 which rotates compressor blades B attached to the outer casing 28. The generator stator 1B rotates in a direction opposite to the generator armature 1A which rotates with turbine shaft 3. As a result of the counter-rotating motion between the stator and armature, there is high rotational speed as observed from the stator/armature. This high rotational speed between armature 1A and stator 1B results in higher changes in magnetic flux as compared to off-the-shelf generators. The high magnetic flux between armature 1A and stator 1B leads to high electrical power density. As a consequence, the electrical generator can be light weight and compact in design.

Shaft 4 drives a plurality of compressor blades B and is driven by the armature 2A of the electrical motor. Shaft 4 is also connected to the electrical generator stator 1B which is driven in an opposite direction to the direction of turbine shaft 3. Since generator stator 1B counter rotates with respect to generator armature 1A, the apparent change in magnetic flux at stator 1B increases considerably. Electrical motor stator 2B remains stationary while armature 2A rotates. The change in magnetic flux at stator 1B increases the power generation density of the electrical generator 1, which makes the counter-rotating module compact and light weight for the same power requirement.

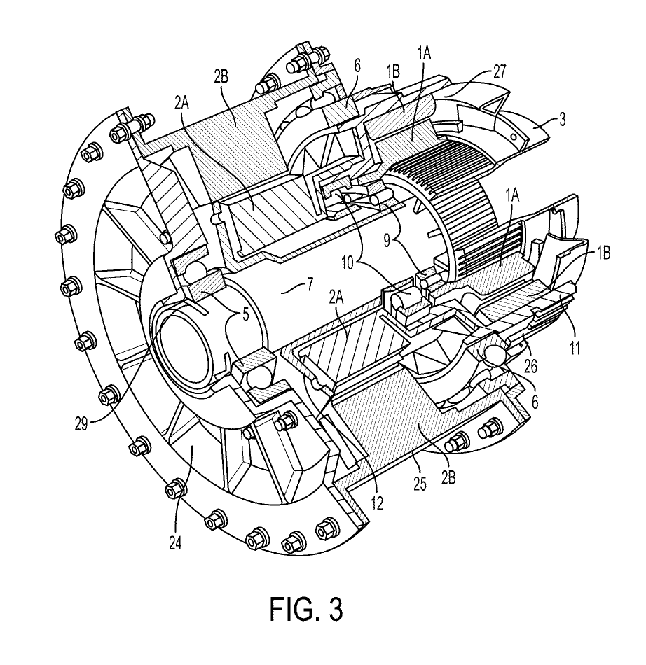

FIG. 2 illustrates a more detailed side cross-sectional view of the exemplary electrically-coupled multi-stage axial compressor with counter-rotation. FIG. 3 illustrates a perspective view of the exemplary electrically-coupled multi-stage axial compressor.

As illustrated in FIGS. 1-3, turbine-driven shaft 3 is connected to armature 1A of the electrical generator. The thrust load on shaft 3 is transferred to the engine frame 23 via rotating shaft 7, thrust bearing 5, contra-rotating (CR) module casing 25 and the engine strut 13. The contra-rotating module casing 25 is connected to the engine struts 20 and 21. Electrical motor stator 2B is connected to the contra-rotating module casing 25. Casing 25 also provides for electrical connections to the power control module (PCM). The armature 2A of the electric motor 2 is connected to flange 11, which connects to the counter-rotating compressor drum 28 including rotors B. Stiffeners 16, 17 are attached to the compressor drum 28 to convey centrifugal loads.

Air flow inlet guide vanes 14 and outlet guide vanes 19 are attached to the compressor casing 15. Compressor drum 28 is radially supported with the help of bearing 18 which is supported on the outlet guide vane 19. Motor armature 2A connects to compressor blades B via shaft 4. Flange 11 is also connected to stator 1B of the electrical generator 1. Stator 1B rotates opposite to the direction of generator armature 1A. The thrust load generated by compressor drum 28 is transferred to the engine frame 23 via flange 11, thrust bearing 6, engine casing 25 and engine strut 13. Radial support to turbine shaft 3 and flange 11 is provided by bearings 9, 10, respectively, which are supported by means of 12 which is connected to the counter-rotating module casing cover plate 24. Seals 26, 27 and 29 are provided for the counter-rotating module.

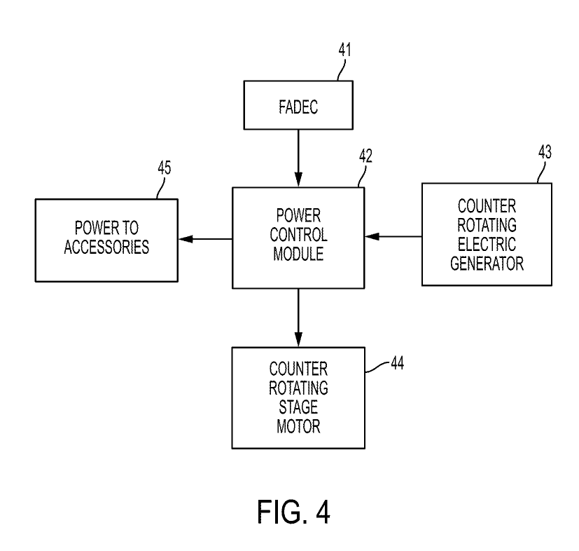

FIG. 4 illustrates a block diagram of the main components of the electrical coupling system. The counter-rotating electrical generator (block 43) powers the power control module (block 42) which, in turn, controls the counter-rotating stage electric motor (block 44) and can power avionics equipment, the air conditioning system, and other onboard electrical accessories (block 45). The FADEC (block 41) controls operation of the power control module (block 42).

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiments are possible without departing from the scope of the present invention. In addition, it is possible to use some of the features of the embodiments disclosed without the corresponding use of the other features. Accordingly, the foregoing description of the exemplary embodiments is provided for the purpose of illustrating the principles of the invention, and not in limitation thereof, since the scope of the invention is defined solely by the appended claims.

What is claimed:

1. A system for providing stage-by-stage counter rotation in a multi-stage axial compressor of a gas turbine engine using electrical coupling comprising:
an electric power generator mounted in an engine core on a gas turbine engine shaft for driving a first plurality of compressor blades;
an electric motor mounted in the engine core on a second shaft for driving a second plurality of compressor blades in an opposite direction from a direction of the first plurality of compressor blades, wherein the first plurality of compressor blades and the second plurality of compressor blades alternate in the compressor on a stage-by-stage basis; and
a power control module for receiving electrical power from the electrical
generator and controlling operation of the electric motor.

2. The system for providing stage-by-stage counter rotation of claim 1 wherein the electric power generator comprises a generator armature coupled to the turbine shaft and a generator stator coupled to the second shaft, the second shaft rotating in an opposite direction from the rotation of the turbine shaft.

3. The system for providing stage-by-stage counter rotation of claim 1 wherein the electric motor comprises a motor stator and a motor armature, the motor armature coupled to the second shaft which drives the second plurality of compressor blades in an opposite direction from the first plurality of compressor blades.

4. The system for providing stage-by-stage counter rotation of claim 1 wherein the rotating armature of the electrical power generator induces a changing magnetic flux in a plurality of stator coils of the generator to generate electrical power.

5. The system for providing stage-by-stage counter rotation of claim 1 wherein the power control module receives electrical power generated by the electrical generator.

6. The system for providing stage-by-stage counter rotation of claim 1 wherein the power control module includes a plurality of power electronics which controls the electric motor and enables electrical power offtake.

7. The system for providing stage-by-stage counter rotation of claim 1 further comprising a full-authority digital engine control which controls operation of the power control module.

8. The system for providing stage-by-stage counter rotation of claim 1 wherein the power control module excites a plurality of coils in the motor stator which drives the motor armature.

9. A system for providing stage-by-stage counter rotation in a multi-stage axial compressor of gas turbine engine comprising:
an electrical power generator mounted in an engine core and including a stator and an armature;
an electric motor mounted in the engine core and including a stator and an armature;
a turbine-driven shaft for driving a first plurality of compressor blades and electrically coupled to the electric generator armature, the electric generator armature inducing a changing magnetic flux in a plurality of stator coils of the generator stator;
a power control module for receiving electrical power from the electrical
generator and controlling the electric motor by exciting a plurality of stator coils in the electric motor to drive the electric motor armature; and
a second shaft driven by the electric motor armature, the second shaft
driving a second plurality of compressor blades in an opposite direction from a direction of the first plurality of compressor blades.

10. The system for providing stage-by-stage counter rotation of claim 9 wherein the stator and armature of the electrical generator are coupled to separate counter-rotating shafts.

11. The system for providing stage-by-stage counter rotation of claim 9 wherein the electric generator stator is coupled to the turbine shaft and the electric generator armature is coupled to the second shaft, the second shaft rotating in an opposite direction from the turbine shaft.

12. The system for providing stage-by-stage counter rotation of claim 9 wherein the changing magnetic flux in the plurality of generator stator coils generates electrical power that is provided to the power control module to control the electric motor and enable aircraft takeoff under electrical power.

13. The system for providing stage-by-stage counter rotation of claim 9 wherein the first plurality of compressor blades and the second plurality of compressor blades alternate in the compressor on a stage-by-stage basis.

14. The system for providing stage-by-stage counter rotation of claim 9 wherein the first plurality of compressor blades are connected to a counter-rotating module casing which is connected to a plurality of engine struts, the casing providing electrical connections to the power control module.

15. The system for providing stage-by-stage counter rotation of claim 9 wherein the second plurality of compressor blades are connected to a counter-rotating compressor drum.

16. The system for providing stage-by-stage counter rotation of claim 9 wherein the electrically coupled counter-rotating shaft system drives onboard avionics and electrically-operated equipment.

17. The system for providing stage-by-stage counter rotation of claim 13 wherein there is no mechanical contact between the turbine shaft and second shaft, the separate shafts providing contra-rotation of the alternating first plurality of compressor blades and the second plurality of compressor blades.

18. The system for providing stage-by-stage counter rotation of claim 13 wherein electrical coupling enables the power control module to provide an adaptable and precise control of revolutions per minute (rpm) of the contra-rotating shafts.

19. A system for providing stage-by-stage counter rotation of compressor blades mounted on separate shafts in a multi-stage axial compressor of a gas turbine engine comprising:
a first plurality of compressor blades driven by a turbine shaft;
a second plurality of compressor blades driven by a second shaft in a direction opposite to the direction of the turbine shaft;
an electrical generator mounted in an engine core for driving the first plurality of compressor blades and providing electrical power to a power control module; and
an electric motor mounted in an engine core for receiving electrical power from the power control module and driving the second plurality of compressor blades in a direction opposite from a direction of the first plurality of compressor blades.

20. The system for providing stage-by-stage counter rotation of claim 19 wherein the electrical generator includes a rotating armature that induces a changing magnetic flux in a plurality of stator coils of the generator to generate electrical power that is provided to the power control module.

21. The system for providing stage-by-stage counter rotation of claim 19 wherein the power control module excites a plurality of coils in a motor stator which drives a motor armature coupled to the second shaft to rotate the second plurality of compressor blades in an opposite direction from the first plurality of compressor blades.

22. The system for providing stage-by-stage counter rotation of claim 19 wherein the first plurality of compressor blades and the second plurality of compressor blades alternate in the compressor on a stage-by-stage basis.
